(19) United States
(12) Patent Application Publication
(10) Pub. No.: US 2006/0007113 A1
(43) Pub. Date: Jan. 12, 2006

(54) Display apparatus and scanning unit

(76) Inventors: In-Sun Hwang, Suwon-si (KR); Jin-Seob Byun, Seoul (KR)

Correspondence Address: McGuire Woods LLP, Suite 1800, 1750 Tysons Boulevard, McLean, VA, 22102, US

(21) Appl. No.: 11/175,674

(22) Filed: Jul. 7, 2005

(30) Foreign Application Priority Data
Jul. 8, 2004 (KR) 10-2004-0052827

(51) Int. Cl. G09G 3/36

(52) U.S. Cl. 345/102

(57) ABSTRACT

The invention provides a display apparatus having improved laser scan times and improved image quality. The display apparatus may include a display unit, a scanning unit, a light generating part, and a scanning part. The scanning unit irradiates a laser beam having image information to the display unit, which displays a visible image to a viewer. The scanning unit includes a light generating part and a scanning part. The light generating part generates the laser beam. The light generating part emits the laser beam and transmits the laser beam to sequentially reflect from one end of a light reflecting part to an opposite end thereof. The scanning part includes at least two scanning mirrors that are transported between upper and lower portions of the display unit to irradiate the laser beam to the display unit. In this manner, scanning speed is increased so that an image display quality is improved.

### CROSS-REFERENCE TO RELATED APPLICATIONS

The present application claims priority to and the benefit of Korean Patent Application No. 2004-52827, filed on Jul. 8, 2004, the disclosure of which is hereby incorporated herein by reference in its entirety.

### BACKGROUND OF THE INVENTION

1. Field of the Invention

The present invention relates to a display apparatus and a scanning unit associated therewith. More particularly, the present invention relates to a display apparatus and associated scanning unit capable of increasing scanning speed to improve image display quality.

2. Description of the Related Art

A conventional rear-projection display apparatus may use a laser beam to generate one or more light patterns that are transmitted to a screen via a scanning unit positioned behind the screen. The transmitted light pattern(s) display a visible image for a viewer positioned on the opposite side of the screen.

Typically, one or more light patterns are scanned in a horizontal fashion from one side of the screen to another, by moving from a start point adjacent one side of the screen to an end point adjacent an opposite side of the screen. This movement causes the one or more light patterns to be scanned across the screen from the start point to the end point. The one or more light patterns are then scanned across the screen from a next start point to a next end point. The time required to move the scanning unit from the start point to the end point or from the next start point to the next end point is called a scanning time period. The time required to move the scanning part from the end point to the next start point is called a recovery time period. A loss of the laser beam decreases when a ratio of the scanning time period to the recovery time period is about five to ten.

To reduce the scanning time period and the recovery time period, conventional approaches have decreased the size of the screen. When the scanning time period and the recovery time period decrease, however, the ratio of the scanning time period to the recovery time period also decreases so that the loss of the laser beam increases. In addition, the scanning time period may overlap the recovery time period in a unit frame so that a net scanning time period decreases.

### SUMMARY OF THE INVENTION

The present invention provides a display apparatus and a scanning unit capable of increasing scanning speed to improve an image display quality.

A display apparatus manufactured according to the principles of the present invention may include a display unit, a scanning unit, a light generating part, and a scanning part. The display unit displays an image. The scanning unit includes a light generating part and a scanning part, and irradiates a laser beam having image information to the display unit. The light generating part generates and emits the laser beam. The scanning part includes at least two scanning mirrors that are transported between upper and lower portions of the display unit to irradiate the laser beam to the display unit.

A scanning unit manufactured according to the principles of the present invention may include a first scanning mirror and a second scanning mirror. During a first frame, the first scanning mirror is transported in a first direction to irradiate a laser beam to a subject. During a second frame that follows the first, the first scanning mirror is transported in a second direction that is opposite to the first direction. During the first frame, the second scanning mirror is transported in the second direction. During the second frame, the second scanning mirror is transported in the first direction to irradiate the laser beam to the subject.

A scanning unit manufactured according to the principles of the present invention may include a scanning mirror and a lifting part. The scanning mirror irradiates an external light to a subject. The lifting part may move the scanning mirror in a direction substantially perpendicular to a surface of the subject so that the light reflected by an angled surface of the scanning mirror is irradiated to the subject along a first direction.

The scanning unit alternately irradiates the laser beam to the display unit during the frames. That is, one of the first and second scanning mirrors irradiates the laser beam to the display unit while another of the first and second scanning mirrors is recovered so that the recovery time period is omitted, thereby increasing a scanning speed of the scanning unit.

### BRIEF DESCRIPTION OF THE DRAWINGS

The above and other advantages of the present invention will become more apparent by describing in detail exemplary embodiments thereof with reference to the accompanying drawings.

FIG. 1 is a perspective view showing a display apparatus in accordance with an exemplary embodiment of the present invention.

FIG. 2 is a cross-sectional view taken along a line I-I′ shown in FIG. 1.

FIG. 3 is a plan view showing a light generating part and a light reflecting part shown in FIG. 1.

FIG. 4 is a plan view showing a light generating part and a light reflecting part of a display apparatus in accordance with another exemplary embodiment of the present invention.

FIG. 5 is a plan view showing a light generating part and a light reflecting part of a display apparatus in accordance with another exemplary embodiment of the present invention.

FIG. 6 is a cross-sectional view showing a display apparatus having the light generating part and the light reflecting part shown in FIG. 5.

FIG. 7 is a cross-sectional view showing a display apparatus in accordance with another exemplary embodiment of the present invention.

FIG. 8 is an enlarged cross-sectional view showing a portion 11 shown in FIG. 7.

### DESCRIPTION OF THE EMBODIMENTS

It should be understood that the exemplary embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

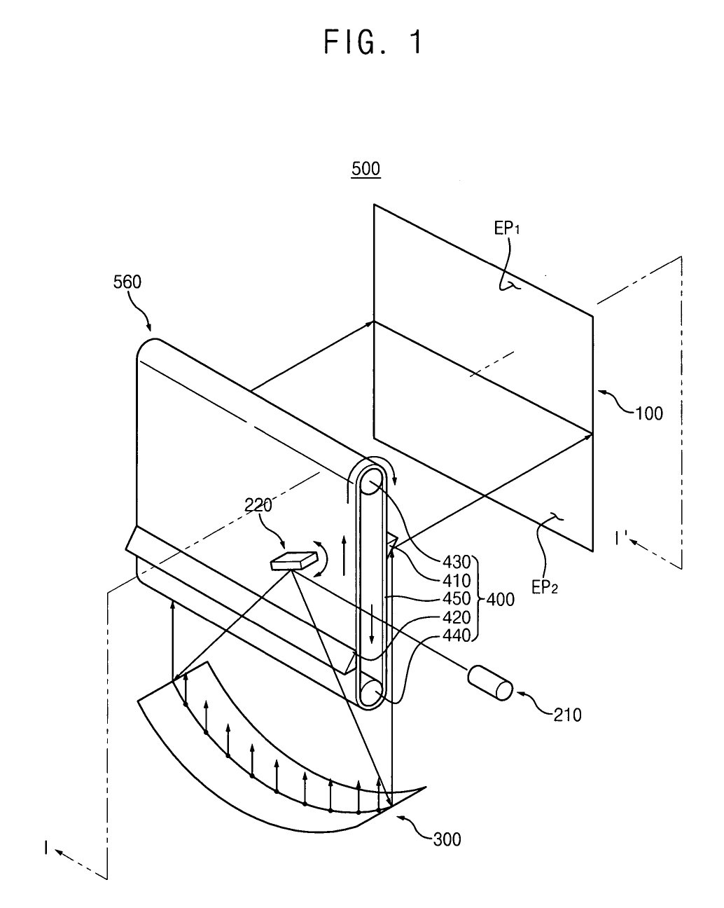

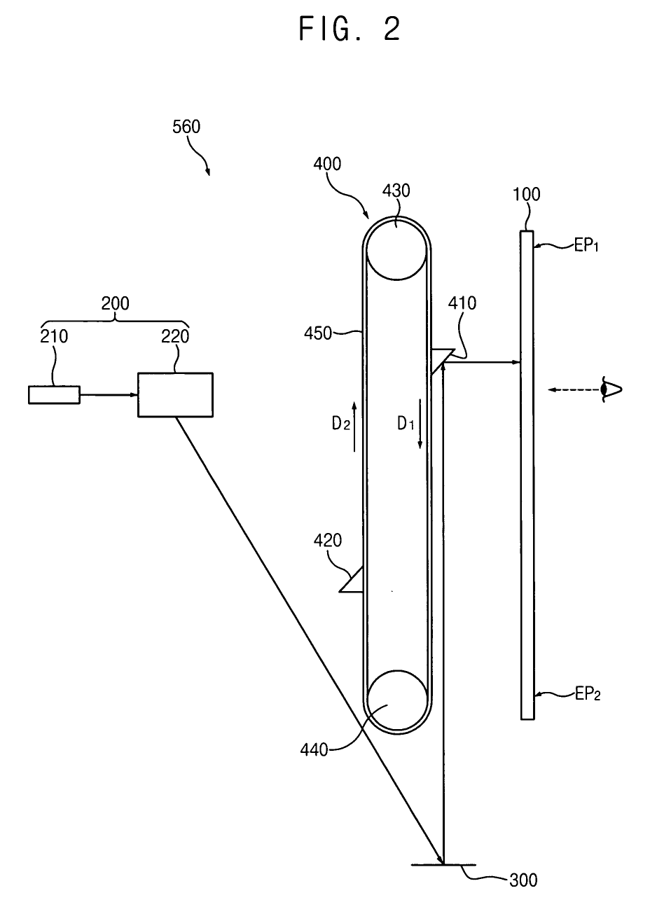

FIG. 1 is a perspective view showing a display apparatus in accordance with an exemplary embodiment of the present invention. FIG. 2 is a cross-sectional view taken along a line I-I′ shown in FIG. 1.

Referring to FIGS. 1 and 2, the display apparatus 500 may include several main components, a display unit 100, a light generating unit 200, a light modulator 220, a light reflecting part 300, and a scanning unit 560. Some or all of these components may be fully or partially enclosed within a cabinet or a frame. For ease of illustration and clarity, neither the cabinet nor the frame are shown in FIGS. 1 and 2.

The display unit 100 may have a front surface viewable by a user of the display apparatus 500 and back surface on a side opposite the front surface. The scanning unit 560 is positioned behind the display unit's back surface.

The display unit 100 may include a rear projection screen that either focuses or diffuses light shining on a back surface thereof to distribute a bright, crisp image into a predefined viewing zone that extends outwardly from the display unit's front surface. The screen may have any thickness, curvature, or size suitable for displaying images having an aspect ratio suitable for widescreen television viewing, standard television viewing, or personal computer viewing.

The scanning unit 560 includes a light generating part 200, a light reflecting part 300, and a scanning part 400. The scanning unit 560 is located in relation to the light generating part 200 and the display unit 100 such that the scanning unit 560 transfers light emitted from the light generating source 200 onto the display unit's back surface. In FIGS. 1 and 2, the scanning unit 560 is illustratively shown positioned between the light generating part 200 and the display unit 100, but other configurations are possible. In operation, the light generating part 200 may generate and emit the laser beam onto sequential points of the light reflecting part 300, which reflects the laser beam towards the scanning part 400. Components of the scanning unit 560 are transported between upper and lower portions EP₁ and EP₂ of the display unit 100 to irradiate the laser beam from the light reflecting part 300 to the back surface of the display unit 100. Each of these components is discussed in more detail below.

Referring again to FIGS. 1 and 2, the scanning part 400 includes a first scanning mirror 410, a second scanning mirror 420, a first roller 430, a second roller 440, and a band 450.

Roller 430 is positioned a pre-determined distance behind an upper portion EP₁ of the display unit's back surface. Roller 440 is positioned about an equal pre-determined distance behind a lower portion EP₂ of the display unit's back surface. Additionally, the first roller 430 is positioned to be spaced apart from and substantially parallel the second roller 440. The width of each roller 430, 440 may approximately equal a width of the display unit's back surface.

The band 450 may be formed of a flexible material and positioned to encircle both rollers 430, 440, and the band's width may approximately equal the width of either of the rollers 430, 440. In the embodiment of FIGS. 1 and 2, the rear surface of the band 450 moves upward from the second roller 440 towards the first roller 430. This upward direction of movement is depicted as D₁. Simultaneously, the front surface of the band 450 moves downward from the first roller 430 toward the second roller 440. This downward direction of movement is designated as D₂. Of course, in other embodiments, the direction of rotation may be reversed.

A first scanning mirror 410 and a second scanning mirror 420 may be coupled to the exterior surface of the band 450 to rotate as the band 45° rotates. A distance between the first and second scanning mirrors 410, 420 is about half a total length L (e.g., circumference) of the band 450. As shown in FIG. 1, a width of each scanning mirror 410, 420 may approximately equal a width of the band 450.

Referring to FIG. 2, each scanning mirror 410, 420 may have a cross-section shaped in the form of a right triangle. A base of each scanning mirror 410, 420 is coupled to the band 450 such that an angled surface of each scanning mirror 410, 420 faces towards the direction of travel.

As shown in FIGS. 1 and 2, a light reflecting part 300 may be positioned beneath and/or slightly in front of the longitudinal axis of the second roller 440 to reflect light emitted from the light generating unit 200 to at least one of the scanning mirrors 410, 420. Of course, in other embodiments, the light reflecting part 300 may be positioned differently, provided the facing direction of each scanning mirror 410, 420 and/or the rotational direction of the band 450 is/are adjusted accordingly.

The light generating unit 200 may include a light modulator 220 and a light source 210. The light modulator may be positioned above the light-reflecting part 300 and in the path of a laser beam emitted from the light source 210.

In use, the light source 210 activates in response from signals received from a controller and emits a laser beam containing image information. The emitted laser beam reflects from the light modulator 220 to the light reflecting part 300, which reflects the laser beam substantially parallel the front surface of the band 450. The band 45° rotates at a velocity that moves the scanning mirror 410 or 420 from the top portion EP₁ of the display unit's back surface to the bottom portion EP₂ of the display unit's back surface in about 1/60^{th} of a second. During this first frame, the first scanning mirror 410 moves in a first direction D₁ from a position parallel the upper portion EP₁ of the display unit 100 to a position parallel the lower portion EP₂ of the display unit 100. As the scanning mirror 410 moves, it irradiates the laser beam to the display unit 100.

At the same time, the second scanning mirror 420 moves in a second direction D₂ from a position adjacent the lower portion EP₂ of the display unit 100 to a position adjacent the upper portion EP₁ of the display unit 100. The second direction D₂ is opposite the first direction D₁. Therefore, the laser beam is not irradiated to the second scanning mirror 420 during the first frame. After the second mirror 420 moves to the upper portion EP₁ of the display unit 100, the second mirror 420 then moves in the first direction D₁ to irradiate the laser beam to the display unit 100 during a second frame. In this manner, an image is projected onto the display unit's back surface about sixty times per second.

The first and second scanning mirrors 410 and 420 are in scanning states when the first and second scanning mirrors 410 and 420 irradiate the laser beams to the display unit 100, respectively. The first and second scanning mirrors 410 and 420 are in recovery states when the first and second scanning mirrors 410 and 420 do not irradiate the laser beams to the display unit 100, respectively.

As mentioned above, the first and second scanning mirrors 410 and 420 are inclined with respect to the display unit 100 so that a front surface of each of the first and second scanning mirrors 410 and 420 forms a predetermined angle with respect to the display unit 100. Therefore, the laser beam that is reflected from the first or second scanning mirror 410 or 420 is incident towards the display unit 100 at an incident angle of about 90°. A velocity of each of the first and second scanning mirrors 410 and 420 may change depending on a size of the display unit 100. That is, when the size of the display unit 100 increases, the velocity of each of the first and second scanning mirrors 410 and 420 increases. However, when the size of the display unit 100 decreases, the velocity of each of the first and second scanning mirrors 410 and 420 decreases.

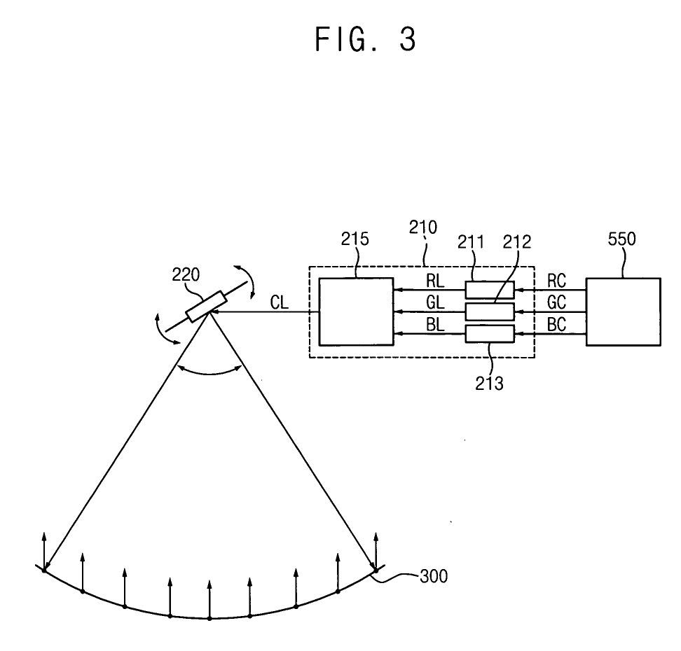

FIG. 3 is a plan view showing a light generating part and a light reflecting part shown in FIG. 1. Referring to FIGS. 1 and 3, the light generating part 200 includes a light source 210 and a light modulator 220. The light source 210 generates mono-colored laser beam portions having red, green and blue wavelengths. The mono-colored laser beam portions from the light source 210 are reflected from the light modulator 220 so that the reflected light from the light modulator 220 passes to the light reflecting part 300.

The light source 210 includes a red laser diode 211, a green laser diode 212 and a blue laser diode 213. The red laser diode 211 generates a red laser beam portion RL having a red wavelength based on a red control signal RC that is from a controlling part 550. The green laser diode 212 generates a green laser beam portion GL having a green wavelength based on a green control signal GC that is from the controlling part 550. The blue laser diode 213 generates a blue laser beam portion BL having a blue wavelength based on the blue control signal BC that is from the controlling part 550. Intensities of the red, green and blue laser beam portions RL, GL and BL are determined by the red control signal RC, the green control signal GC, and the blue control signal BC, respectively.

The light source 210 further includes a light mixing part 215. The light mixing part 215 mixes the red, green and blue laser beam portions RL, GL and BL into a laser beam CL. The laser beam CL is irradiated to the light modulator 220.

In this exemplary embodiment, the light modulator 220 is a vibration mirror. Alternatively, the light modulator 220 may be a polygonal rotation mirror. The vibration mirror is inclined at a predetermined angle with respect to the laser beam CL. When the vibration mirror vibrates, an incident angle of the laser beam CL that impinges the vibration mirror changes. When the incident angle of the laser beam CL changes, an exit angle of the laser beam CL also changes. That is, the laser beam CL is reflected from one sequential adjacent position to another as the vibration mirror changes position.

In this exemplary embodiment, the light reflecting part 300 is a concave mirror. The laser beam CL reflected from the light modulator 220 may be sequentially irradiated to different positions of the concave mirror. For example, as the light modulator 220 rotates, the laser beam CL from the vibration mirror may move from a first end portion of the concave mirror to a second opposite end portion of the concave mirror.

Thereafter, the laser beam CL sequentially reflects from each portion of the light reflecting part 300 to a corresponding sequential portions of the first or second scanning mirror 410 or 420. From the first or second scanning mirror 410 or 420, the sequentially reflected laser beam CL is irradiated to the back surface of the display unit 100.

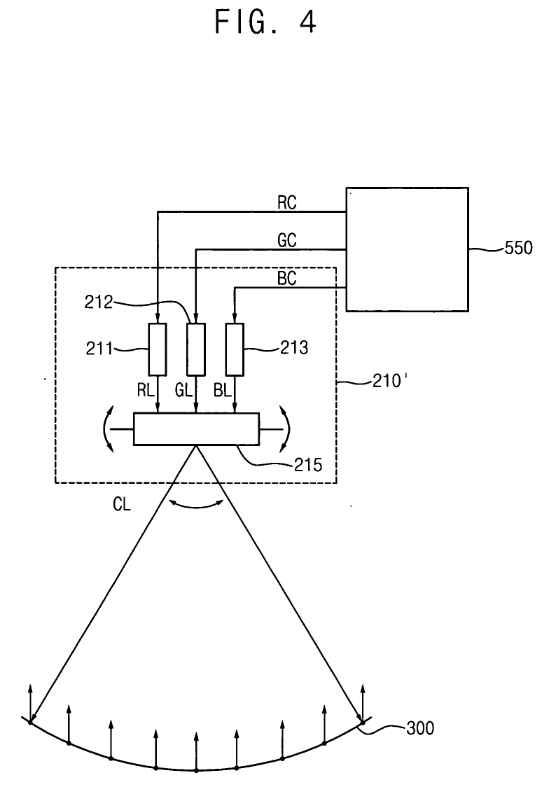

FIG. 4 is a plan view showing a light generating part and a light reflecting part of a display apparatus of another embodiment of the present invention. The display apparatus of FIG. 4 is same as in FIGS. 1 to 3 except that this embodiment does not include a light generating part or a light reflecting part. Thus, the same reference numerals will be used to refer to the same or like parts as those described in FIGS. 1 to 3 and any further explanation concerning the above elements will be omitted.

Referring to FIGS. 1 and 4, the light generating part 200 includes a light source 210′ that generates mono-colored laser beam portions having red, green and blue wavelengths.

The light source 210′ includes a red laser diode 211, a green laser diode 212 and a blue laser diode 213. The red laser diode 211 generates a red laser beam portion RL having a red wavelength based on a red control signal RC that is from a controlling part 550. The green laser diode 212 generates a green laser beam portion GL having a green wavelength based on a green control signal GC that is from the controlling part 550. The blue laser diode 213 generates a blue laser beam portion BL having a blue wavelength based on the blue control signal BC that is from the controlling part 550. Intensities of the red, green and blue laser beam portions RL, GL and BL are determined by the red control signal RC, the green control signal GC and the blue control signal BC, respectively.

The light source 210′ further includes a light mixing part 215. The light mixing part 215 mixes the red, green and blue laser beam portions RL, GL and BL into a laser beam CL. In addition, the light mixing part 215 vibrates in a predetermined range with respect to a rotation angle to guide the laser beam CL so that the laser beam CL is irradiated to the light reflecting part 300 from a first end portion to a second end portion of a light reflecting part 300 that is a convex mirror, in sequence. Alternatively, the light mixing part 215 may include a light mixing portion and a light reflecting portion that is integrally formed on the light mixing portion.

According to this exemplary embodiment, the light mixing part 215 vibrates so that the laser beam CL guided by the light mixing part 215 is irradiated to different positions of the light reflecting part 300. That is, the light mixing part 215 and the light modulator 220 shown in FIG. 3 are integrally formed with each other so that additional vibration mirror may be omitted. The light reflecting part 300 reflects the modulated laser beam CL to be substantially parallel a front surface of the band 450. As each of the first or second scanning mirrors 410 or 420 moves from position EP1 to EP2, it reflects the laser beam CL to the back surface of the display unit 100.

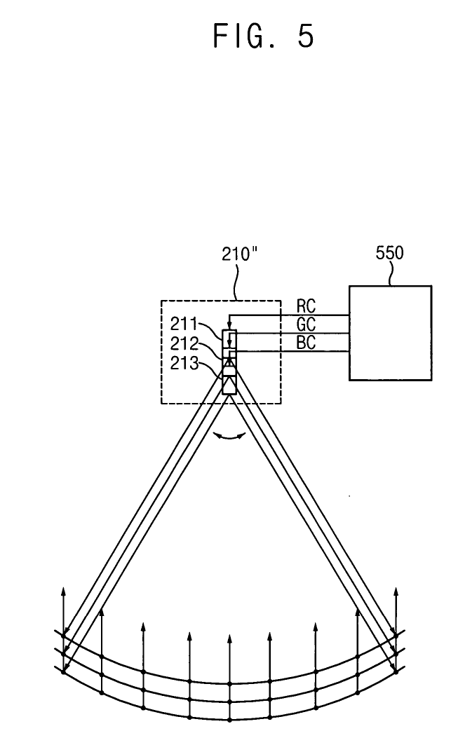

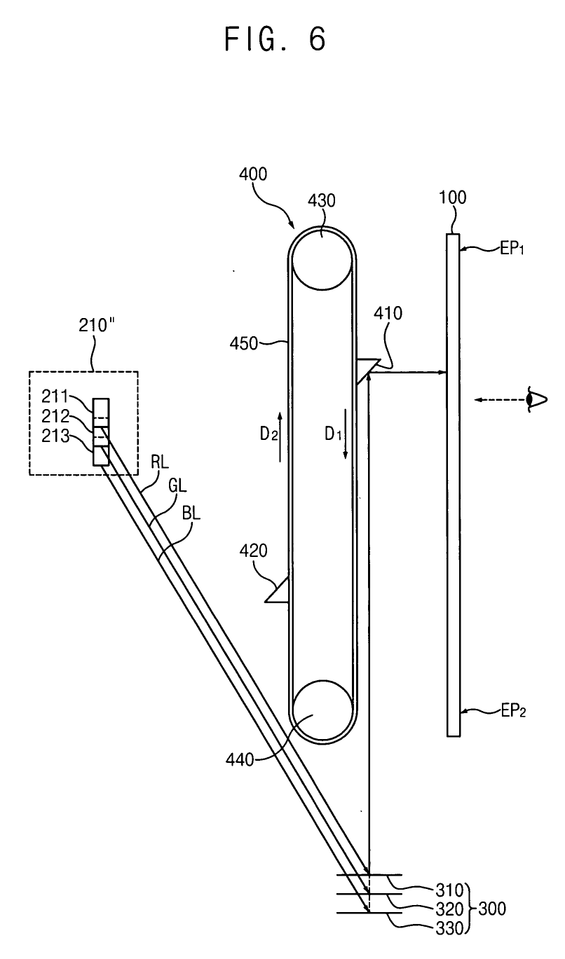

FIG. 5 is a plan view showing a light generating part and a light reflecting part of a display apparatus in accordance with another exemplary embodiment of the present invention. FIG. 6 is a cross-sectional view showing a display apparatus having the light generating part and the light reflecting part shown in FIG. 5.

Referring to FIGS. 1, 5, and 6, the light generating part 200 includes a light source 210Δ that generates a laser beam having red, green and blue wavelengths.

The light source 210″ includes a red laser diode 211, a green laser diode 212 and a blue laser diode 213. The red laser diode 211 generates a red laser beam RL having the red wavelength based on a red control signal RC that is from a controlling part 550. The green laser diode 212 generates a green laser beam GL having the green wavelength based on a green control signal GC that is from the controlling part 550. The blue laser diode 213 generates a blue laser beam BL having the blue wavelength based on the blue control signal BC that is from the controlling part 550. Intensities of the red, green and blue laser beam portions RL, GL and BL are determined by the red control signal RC, the green control signal GC and the blue control signal BC, respectively.

Each of the red, green and blue laser diodes 211, 212 and 213 vibrates in a predetermined range to guide each of the red, green and blue laser beam portions RL, GL and BL into different positions of the light reflecting part 300. Alternatively, the red, green and blue laser beam portions RL, GL and BL may be reflected in the red, green and blue laser diodes 211, 212 and 213, respectively, so that the red, green and blue laser beam portions RL, GL, and BL are guided.

The light reflecting part 300 may include a first convex mirror 310, a second convex mirror 320, and a third convex mirror 330. The red laser beam RL is sequentially irradiated to adjacent portions of the first convex mirror 310, and the red laser beam RL is then reflected from the first convex mirror 310 to substantially parallel a front surface of the band 450. The green laser beam GL is sequentially irradiated to adjacent portions of the second convex mirror 320, in sequence, and the green laser beam GL is then reflected from the second convex mirror 320 to substantially parallel a front surface of the band 450. After the blue laser beam BL is sequentially irradiated to adjacent portions of the third convex mirror 330, the blue laser beam BL is reflected from the third convex mirror 330 to substantially parallel a front surface of the band 450. Each mirror 310, 320, and 330 may be positioned such that the reflected RL, GL, and BL substantially overlaps before being reflected by the scanning mirror 410 or 420 to the back surface of the display unit 100.

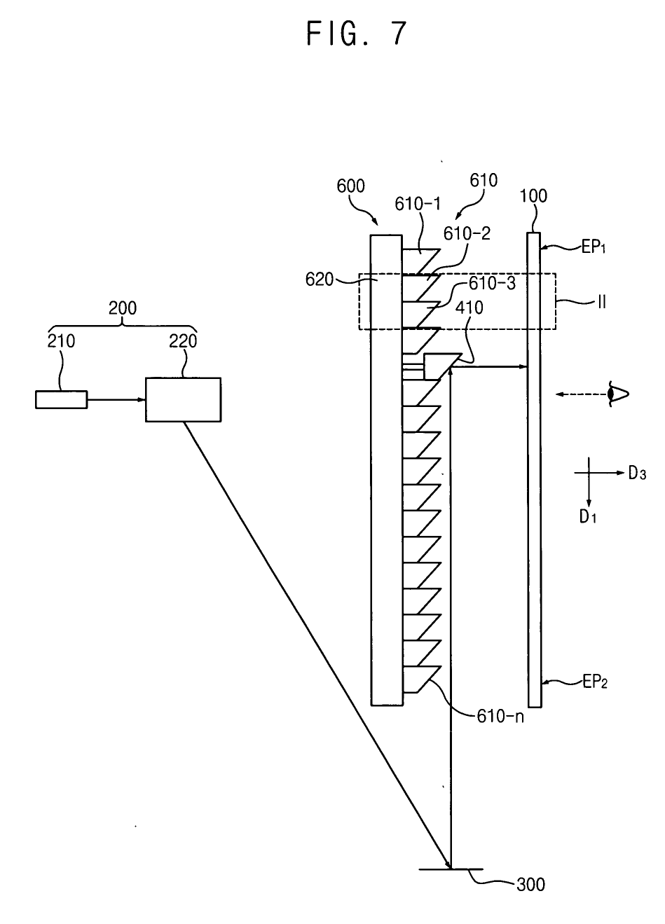

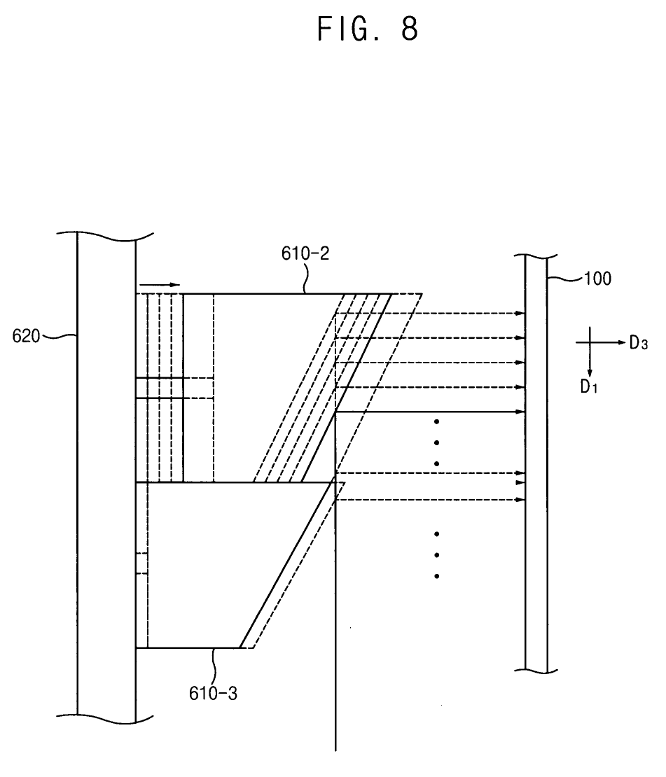

FIG. 7 is a cross-sectional view showing a display apparatus in accordance with another exemplary embodiment of the present invention. FIG. 8 is an enlarged cross-sectional view showing a portion 11 shown in FIG. 7. Referring to FIGS. 7 and 8, a scanning unit 600 of the display apparatus 700 includes first, second, . . . nth scanning mirrors 610-1, 610-2, . . . 610-n and a lifting part 620. The lifting part 620 outwardly lifts the first, second, . . . n^{th} scanning mirrors 610-1, 610-2, . . . 610-n towards the display unit 100 in a third direction D3 that is substantially perpendicular the planar back surface of the display unit 100. Unlike the rotatable scanning unit 560 of FIGS. 1-6, the scanning unit 600 does not rotate. Instead, the laser beam is sequentially scanned from a top portion EP₁ of the display unit's back surface to a bottom portion EP₂ of the display unit's back surface by sequentially raising the first, second . . . n^{th} scanning mirrors 610-1, 610-2, and 610-n.

The first, second, . . . n^{th} scanning mirrors 610-1, 610-2, . . . 610-n may be arranged in a first direction D1 that substantially parallels the back surface of the display unit 100. The scanning sections of the first, second, . . . n^{th} scanning mirrors 610-1, 610-2, . . . 610-n are inclined with respect to the third direction D3 by a predetermined angle so that a laser beam from the light reflecting part 300 is reflected from the first, second, . . . n^{th} scanning mirrors 610-1, 610-2, . . . 610-n toward the back surface of the display unit 100.

In use, the lifting part 620 sequentially lifts the first, second, . . . nth scanning mirrors 610-1, 610-2, . . . 610-n in a third direction D3 that is substantially perpendicular to the display unit 100, so that positions on the display unit 100 is scanned are sequentially changed. In particular, the lifting part 620 moves the first scanning mirror 610-1 in the third direction D3 at a predetermined speed. The laser beam from the light reflecting part 300 is reflected from the first scanning mirror 610-1 to be irradiated to the display unit 100. When the first scanning mirror 610-1 is transported in the third direction D3, the laser beam is sequentially irradiated to the display unit 100.

After the laser beam is scanned using the first scanning mirror 610-1, the laser beam is also scanned by the second scanning mirror 610-2. In particular, the lifting part 620 moves the second scanning mirror 610-2 in the third direction D3 at the speed substantially same as that of the first scanning mirror 610-1. The laser beam from the light reflecting part 300 is reflected from the second scanning mirror 610-2 to be irradiated to the display unit 100. When the second scanning mirror 610-2 is transported in the third direction D3, the laser beam is sequentially irradiated to the display unit 100.

After the laser beam is scanned using the second scanning mirror 610-2, the laser beam is scanned by the third scanning mirror 610-3. Thus the lifting part 620 sequentially moves the first, second, . . . n^{th} scanning mirrors 610-1, 610-2, . . . 610-n to scan the laser beam on the display unit 100 using each of the first, second, . . . n^{th} scanning mirrors 610-1, 610-2, . . . 610-n.

The lifted first, second, . . . n^{th} scanning mirrors 610-1, 610-2, . . . 610-n may be simultaneously lowered. Alternatively, the first, second, . . . n^{th} scanning mirrors 610-1, 610-2, . . . 610-n may be upwardly lifted and lowered, in sequence.

When a size of the display unit 100 increases, the number of the scanning mirrors increases so that the laser beam may be scanned on an entire surface of the scanning unit. In addition, when the size of the display unit 100 increases, a size of each of the scanning mirrors may also increase so that the laser beam may be scanned on the entire surface of the scanning unit. That is, the number of the scanning mirrors is determined by the sizes of the display unit 100 and the scanning mirrors.

An advantage of the invention is that the scanning unit includes the first and second scanning mirrors to scan an emitted laser beam to the display unit. That is, the first and second scanning mirrors alternately irradiate the laser beam to the display unit during alternate, sequential frames so that the recovery time period is omitted, thereby increasing a scanning speed of the scanning unit.

Alternatively, the scanning unit may include a plurality of scanning mirrors that are transported in a direction substantially perpendicular to the display unit, and are sequentially lifted, so that the laser beam is irradiated to the display unit. This configuration eliminates, the recovery time period, thereby increasing the scanning speed of the scanning unit.

This invention has been described with reference to various exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A display apparatus, comprising:
a display unit to display an image;
a light reflecting part; and
a scanning unit to irradiate a laser beam having an image information to the display unit, the scanning unit including:
a light generating part to generate the laser beam, the light generating part emitting the laser beam sequentially from one portion of the light reflecting part to another portion of the light reflecting part; and
a scanning part having at least two angled scanning mirrors that are transported between upper and lower portions of the display unit to irradiate the reflected laser beam received from the light reflecting unit to the display unit.

2. The display apparatus of claim 1, wherein the scanning part comprises:
a first scanning mirror of the at least two scanning mirrors that is transported from the upper portion to the lower portion of the display unit during a first frame to irradiate the laser beam to the display unit, wherein the first scanning mirror is recovered from the lower portion to the upper portion of the display unit during a second frame; and
a second scanning mirror of the at least two scanning mirrors that is recovered from the lower portion to the upper portion of the display unit during the first frame, wherein the second scanning mirror is transported from the upper portion to the lower portion of the display unit during the second frame to irradiate the laser beam to the display unit.

3. The display apparatus of claim 2, wherein the first scanning mirror and the second scanning mirror each have an angled surface facing a direction in which the first and second scanning mirror are rotated.

4. The display apparatus of claim 2, wherein the scanning part comprises:
a first roller corresponding to the upper portion of the display unit, the first roller rotating in a predetermined direction;
a second roller corresponding to the lower portion of the display unit, the second roller rotating in a direction substantially the same as the first roller; and
a band coupled with the first and second rollers, the band being rotated between the upper and lower portions of the display unit by the first and second rollers.

5. The display apparatus of claim 4, wherein the first and second scanning mirrors are spaced apart from each other, are combined with the band, and are transported by the band.

6. The display apparatus of claim 5, wherein a distance between the first and second rollers is substantially same as about a half of a total length of the band.

7. The display apparatus of claim 1, wherein the scanning unit further comprises:
a lifting part to upwardly lift each of the at least two scanning mirrors in a direction substantially perpendicular to a surface of the display unit so that the laser beam reflected from each scanning mirror is transported in a first direction and irradiated to the display unit.

8. The display apparatus of claim 7, wherein the at least two scanning mirrors that are arranged in a first direction to substantially parallel a back surface of the display unit, and wherein the lifting part upwardly lifts each of the at least two scanning mirrors in the first direction, in sequence.

9. The display apparatus of claim 1, wherein the light generating part comprises:
a plurality of light sources to generate a plurality of mono-colored laser beam portions having different wavelengths from one another; and
a light mixing part to mix the mono-colored laser beam portions into the laser beam.

10. The display apparatus of claim 9, wherein the light source comprises:
a red diode to generate a red laser beam portion that has a red wavelength;
a green diode to generate a green laser beam portion that has a green wavelength; and
a blue diode to generate a blue laser beam portion that has a blue wavelength.

11. The display apparatus of claim 9, wherein the light generating part further comprises a vibration mirror that reflects the laser beam from the light mixing part to different positions of the light reflecting part based on a vibration of the vibration mirror.

12. The display apparatus of claim 11, wherein the light reflecting part comprises a convex mirror, and the vibration mirror vibrates in a predetermined range so that the laser beam from the vibration mirror is irradiated from a first end portion to a second end portion of the concave mirror.

13. The display apparatus of claim 1, wherein the light generating part comprises:
a red laser diode that generates a red laser beam portion, wherein the red laser diode vibrates to guide the red laser beam portion into different positions of the scanning unit;
a green laser diode that generates a green laser beam portion, wherein the green laser diode vibrates to guide the green laser beam portion into different positions of the scanning unit; and
a blue laser diode that generates a blue laser beam portion, wherein the blue laser diode vibrates to guide the blue laser beam portion into different positions of the scanning unit.

14. The display apparatus of claim 13, wherein the light reflecting part includes multiple reflectors that respectively reflects the red, green and blue laser beam portions from the red, green and blue laser diodes a to the display unit in a substantially same and overlapping direction.

15. The display apparatus of claim 14, wherein the multiple reflectors comprise:
a first convex mirror from which the red laser portion from the red laser diode is reflected to impinge one of the at least two scanning mirrors;
a second convex mirror from which the green laser portion from the green laser diode is reflected to impinge the one of the at least two scanning mirrors; and
a third convex mirror from which the blue laser portion from the blue laser diode is reflected to impinge the one of the at least two scanning mirrrors.

16. A scanning unit, comprising:
a first scanning mirror transported in a first direction during first frame to irradiate a laser beam to a subject, wherein the first scanning mirror is transported in a second direction opposite to the first direction during a second frame that is after the first frame; and
a second scanning mirror transported in the second direction during the first frame, wherein the second scanning mirror is transported in the first direction during the second frame to irradiate the laser beam to the subject.

17. The scanning unit of claim 16, further comprising:
a first roller corresponding to an upper portion of the subject, the first roller rotating in a predetermined direction;
a second roller corresponding to a lower portion of the subject, the second roller rotating in a direction substantially same as the first roller; and
a band combined with the first and second rollers, the band being rotated by the first and second rollers.

18. The scanning unit of claim 17, wherein the first and second scanning mirrors are coupled with the band to be transported between the upper and lower portions of the subject, and a distance between the first and second rollers is substantially same as about a half of a total length of the band.

19. A scanning unit, comprising:
a scanning mirror to irradiate a laser beam to a display unit; and
a lifting part to move the scanning mirror in a direction substantially perpendicular to a back surface of the display unit so that the light reflected from the scanning mirror is irradiated to the back surface of the display unit along a first direction.

20. The scanning unit of claim 19, further comprising a plurality of scanning mirrors arranged to substantially parallel the back surface of the display unit, wherein each of the scanning mirrors is moved in the first direction by the lifting part, in sequence.
